(19) United States
(12) Patent Application Publication
(10) Pub. No.: US 2018/0086667 A1
(43) Pub. Date: Mar. 29, 2018

(54) Cement Containing Forms with Insulating Properties

(71) Applicant: Franklin Prante, Waldport, OR (US)

(72) Inventor: Franklin Prante, Waldport, OR (US)

(21) Appl. No.: 15/812,172

(22) Filed: Nov. 14, 2017

Related U.S. Application Data
(60) Provisional application No. 62/400,936, filed on Sep. 28, 2016.

(51) Int. Cl. C04B 16/08; C04B 28/18; C04B 24/26; E04B 2/86; E04G 9/02; E04G 9/10; B28B 11/24

(52) U.S. Cl. CPC C04B 16/08; C04B 28/18; C04B 24/2641; E04B 2/86; C04B 2111/00612; E04G 9/10; B28B 11/243; C04B 2201/30; E04G 9/02

(57) ABSTRACT

Various cement-containing forms and related compositions and methods are disclosed herein. Some cement-containing forms disclosed in this application include cement and expanded polystyrene. The cement forms, in some cases, are formed by a process that involves combining cement and expanded polystyrene with one or more liquids that interact with the expanded polystyrene to improve adhesion between the cement and the expanded polystyrene. The resulting forms may provide insulating properties. Some of the disclosed cement-containing forms and compositions may also have a relatively low density in comparison with other cement-containing compositions.

### CROSS REFERENCE TO RELATED APPLICATIONS

This application claims priority to U.S. Provisional Patent Application Ser. No. 62/400,936 filed on Sep. 28, 2016 entitled “CEMENT-CONTAINING FORMS WITH INSULATING PROPERTIES”, the disclosure of which is hereby incorporated by reference.

### BACKGROUND OF THE INVENTION

The present disclosure relates generally to the field of cement-containing forms and related methods. More particularly, some embodiments relate to cement containing forms with insulating properties.

A further understanding of the present invention can be obtained by reference to a preferred embodiment set forth in the accompanying description. Although the illustrated embodiments are merely exemplary of methods for carrying out the present invention, both the organization and method of operation of the invention, in general, together with further objectives and advantages thereof, may be more easily understood by reference to the illustrations and the following description. The figures are not intended to limit the scope of this invention, but merely to clarify and exemplify the invention.

### BRIEF DESCRIPTION OF THE DRAWINGS

The written disclosure herein describes illustrative embodiments that are nonlimiting and non-exhaustive. Reference is made to certain of such illustrative embodiments that are depicted in the figures, in which:

FIG. 1 is a perspective view of cement-containing forms for use in constructing walls.

FIG. 2 is a partially cutaway perspective view of the cement-containing forms of FIG. 1.

### DETAILED DESCRIPTION OF THE INVENTION

The following detailed description of various embodiments is not intended to limit the scope of the present disclosure, but is merely representative of various embodiments. The present disclosure relates generally to the field of cement-containing forms and related methods. More particularly, some of the embodiments relate to cement-containing forms with insulating properties.

Insulated cement-containing forms can be used to pour concrete walls. Generally, the cement-containing forms become a permanent part of the resulting wall. In other words, the forms stay in place as a permanent part of the wall assembly.

Some cement-containing forms may be pre-formed interlocking blocks or separate panels connected by ties (e.g., plastic ties). The left-in-place forms may provide a continuous insulation and sound barrier. The forms may also supply (1) a backing for drywall or other finishes on the side surface of the wall and/or (2) a backing for stucco, lap siding, brick, etc. on the outside. Insulated cement forms can differ widely in the details of their shapes, cavities, and component parts. Block systems generally have the smallest individual units. The individual units of block systems may have any suitable size, such as 8″×1′4″ to 1′4″×4′. A typical block is 10″ in overall width, with a 6″ cavity for the concrete. The blocks may be designed to fit with one another via special interlocking edges that fit together like plastic children's blocks.

Panel systems generally have relative large individual units, ranging from roughly 1′×8′×3″ to 4′×12′×3″. The edges of the panel systems may be flat. The panels may be interconnected by attachment of a separate connector or “tie.” Panels are generally assembled into units either on site or by the local distributor prior to delivery. Plank systems are similar to panel systems, but generally use smaller faces of foam, ranging in height from 8″ to 12″ (or more) and in length from 4′ to 8′ (or more). The major difference between planks and panels is the method of assembly. The foam planks are outfitted with ties as part of the setting sequence, rather than pre-assembled into units.

Insulated cement forms can vary in the design of their cavities. “Flat wall” systems yield a continuous thickness of concrete, like a conventional poured wall. “Waffle grid wall” systems have a waffle pattern where the concrete is thicker at some points than others. “Screen grid” systems have equally spaced horizontal and vertical columns of concrete which are completely encapsulated in polystyrene or engineered polymer.

As used herein, the term “cement-containing form” refers to a form that is made from a cement-containing composition. The term does not encompass forms that are used for shaping a cement-containing composition when the form itself is not made from a cement-containing composition. Concrete typically includes four primary components: cement (e.g., Portland cement), sand, gravel, and water. However, forms made from only these components have limited utility due to several factors.

First, such forms have relatively high densities. The increased weight of such high-density forms can be problematic in many instances. For instance, such forms may be difficult to transport. Second, such forms may provide insufficient insulation properties for some purposes. Third, such forms may have insufficient compression or tension strength for particular applications. Certain embodiments disclosed herein can address one or more of these deficiencies.

In some embodiments, the cement of the cement-containing form may be mixed with water to approximately 6% or until wet enough to stick to other components in the mixture. In some embodiments, no more than three to four gallons of water is used per 100 pounds of cement. The amount of water will generally vary with geography and the amount of the other components in the mixture. Too much water may lengthen the time the product takes to set, separate the ingredients, allow the polystyrene to float, and/or weaken the product.

The cement-containing forms may include one or more of expanded polystyrene, perlite, and vermiculite. For example, in some embodiments, the cement containing form includes expanded polystyrene (e.g., Styrofoam). The inclusion of low density aggregate (such as beads of expanded polystyrene) in the composition used to make the cement-containing form may lower the density of the resulting cement containing form. The inclusion of expanded polystyrene may, additionally or alternatively, endow the resulting form with increased insulation properties. In other words, the resulting form may be a better insulator than a concrete form that lacks expanded polystyrene or other low-density aggregate.

In some embodiments, the ratio of cement to expanded polystyrene or other low-density aggregate is between 1:2 and 1:15. For example, in some embodiments, the ratio of cement to expanded polystyrene is between 1:3 and 1:10, between 1:4 and 1:9, and/or between 1:5 and 1:8 by volume. In some embodiments, expanded polystyrene is greater than 70%, 80%, and/or 85% of the volume of the form. In some embodiments, the expanded polystyrene used in making the cement containing form is a closed-cell foam provided in the form of granules, pellets, or beads. For example, in some embodiments, the expanded polystyrene of the cement containing form is provided as beads, pellets, or granules of less than ¼ inch in diameter. The expanded polystyrene can be sourced from Styrofoam waste.

In some embodiments, the cement of the cement-containing form is a cement that comprises calcium oxide and silica. For example, in some embodiments, the cement of the cement-containing form is Portland cement (e.g., Type I, Type II, or Type III). Other suitable cements include Class A cement, high-performance Class H cement, or hydraulic cement. In other embodiments, a cement substitute may be used, such as masonry cement, mortar, polymer-modified mortar (e.g., Ultraflex® 2), grout, plaster, or plaster substitutes.

In some embodiments, the cement-containing form may further include one or more acrylic components, such as acrylic enamel, acrylic urethane, and acrylic lacquer. The acrylic component may interact with a relatively low-density material, such as expanded polystyrene, to improve the structural characteristics of the resulting cement containing form. In some embodiments, the cement-containing form is approximately 14%-20% cement by volume. In some embodiments, the cement-containing form is approximately 45%-65% (e.g., 50%-60%) cement by volume. Increasing the amount of cement may make the resulting cement-containing form stronger and/or heavier.

For example, in some embodiments, the acrylic component may interact with the expanded polystyrene to improve adhesion between the expanded polystyrene and the cement, thereby producing a cement-containing form with increased structural integrity. In some embodiments, the acrylic component of the cement-containing form is less than 5%, less than 2%, and/or less than 1% of the cement-containing form by volume. For example, the acrylic component may be between 0.5% and 2% of the volume of the form in some embodiments. In some embodiments, the form may include an acrylic hardener, such as acrylic urethane hardener. The hardener may help set the end product to a greater strength and/or lower volatile organic compound emission, thereby enabling compliance with emission standards.

In some embodiments, the form may include one or more polymer-based sealers, such as KSC Komponent®. KSC Komponent® includes silicone dioxide (7.70%), aluminum oxide (7%), iron oxide (1.17%), calcium oxide (50.06%), magnesium oxide (0.08%), sulfur trioxide (26.04%), total alkalis such as Na2O (0.56%), and insoluble residue (2.38%). Such sealers may allow the product to flex up to ¼ inches without cracking as it cures. Such sealers may allow the product to flex and, because of this, reduce cracking as the product is heated. Such sealers may also improve the insulation and/or the strength of the product. Such sealers may create type-K cement. The sealer may accelerate drying time, close pores on the cement, prevent cracking, and/or allow the product to expand or contract. The expansion of type-K cement, when mixed with sufficient water, may be primarily due to formation of the crystal ettringite. Hydraulic cements and carbon-enhanced cement may be added (from 1%-10%).

In some embodiments, the cement-containing form may include hard polypropylene fibers (typically less than 1% by volume). Such fibers can add vertical and/or horizontal structure. Carbon metal fibers, titanium fibers, stainless steel metal fibers, or other metal fibers or shavings can additionally or alternatively be added to strengthen the forms. In some embodiments, the fibers and/or shavings may increase the holding power of the forms for nails, screws, or other fasteners. A fiber mat may also be applied to the cement-containing form.

In other or further embodiments, the cement-containing form may be formed from a cement-containing composition that includes one or more other chemical additives, such as ethers (e.g., diethyl ether), methylene chloride, methyl ethyl ketone, 1,3,-diethenyl benzene, benzene, ethyl benzene, heptane, 1,3,5-trimethylbenzene, 1,3,5-trimethylbenzene mesitylene, alcohols (e.g., methanol, ethanol, etc.), methylcyclohexane, naphtha, naphthalene, gasoline, propane, petroleum resins, Stoddard solvent, triethanolamine, toluene, or xylene. These liquids may, like the acrylic components described above, interact with (e.g., partially dissolve) the low-density material (e.g., expanded polystyrene) to improve adhesion between the low-density material and the cement. Such components may also increase the strength and/or water resistance of the resulting form.

In some embodiments, one or more acids or other additives can be used to break down the surface of the expanded polystyrene, such as acetic acid ethenyl ester, N-butyl acetate, 1-methoxy-2-propyl acetate, 2-butoxyethyl acetate, D-limonene, and muriatic acid. In some embodiments, one or more bases can be used to break down the surface of the expanded polystyrene. Examples of bases include dilute red phosphorus, lye, lime, or any suitable base having a pH greater than 9. The acid(s) and/or base(s) may improve adhesion between the polystyrene and the cement.

In some embodiments, a superplasticizer (also known as high-range water reducers) may be used as a dispersant to avoid particle segregation, and to improve the flow characteristics (rheology) of suspensions. The addition of superplasticizers may allow for a reduction of the water-to-cement ratio without affecting the workability of the mixture. Such plasticizers may additionally or alternatively enable the production of self-consolidating concrete and high-performance concrete. One such superplasticizer is Verifi®.

In some embodiments, the cement-containing form may lack or have low amounts (e.g., less than 2% by volume) of sand and/or gravel. Limiting the amount of sand and/or gravel in the cement-containing form may reduce the density of the cement-containing form. However, sand, in some instances, can increase strength. For example, sand may be used in some instances for interior walls.

In some embodiments, the density of the cement-containing form is less than the density of a form that differs from the cement-containing form only in that the expanded polystyrene (or other low-density material) is replaced with an equivalent volume of sand. In some embodiments, the density of the cement-containing form is less than the density of solid steel, aluminum, and/or wood.

In some embodiments, the cement-containing form has a resistive strength for compression that is greater than 700, 1000, 2000, 3000, 4000, and/or 5000 pounds per square inch (psi). Resistive strength can be measured by preparing a cylindrically shaped mass of cement used to create a cement-containing form and then subjecting the cylinder to compression until it breaks. High resistive strength may allow for the use of forms having relatively large heights (e.g., 12-foot heights). The strength of the cement-containing form may facilitate the manufacture of walls that are plum, level, and square. The strength of the cement-containing form may also reduce the need for scaffolding around the exterior of a building. The strength of the cement-containing form may also remove the need to attach addition support systems (e.g., metal frameworks).

In some embodiments, the cement-containing form provides increased insulation properties relative to other cement-containing forms. For example, some cement-containing forms described herein may have an R-value that is greater than the R-value of a form that differs from the cement-containing composition only in that the polystyrene (or other low-density material) is replaced with an equivalent volume of sand or gravel.

In some embodiments, a water-proofing agent, such as particular silanes (e.g., triethoxycapryltylsilane in Rheopel Plus™), may be applied to the resulting cement-containing form to improve resistance to water. Compression may also further waterproof the product.

To manufacture a cement-containing form, expanded polystyrene (or some other low-density material with insulation properties) may be added to the cement. The expanded polymer (e.g., expanded polystyrene) can be added by a conveyor belt or other means. One or more chemical additives may be added to the cement/expanded polystyrene mixture, or to the expanded polystyrene before or after being mixed with the cement. For example, in some embodiments, an acrylic component, such as acrylic enamel, acrylic urethane, or acrylic lacquer, may be added to the mixture that includes cement and the low-density material (e.g., expanded polystyrene). In other or further embodiments, one or more of the following chemical additives may be added to the mixture: ethers (e.g., diethyl ether), methyl ethyl ketone, 1,3,-diethenyl benzene, benzene, ethyl benzene, heptane, 1,3,5-trimethylbenzene, 1,3,5-trimethylbenzene mesitylene, alcohols (e.g., methanol, ethanol, etc.), methylcyclohexane, naphtha, naphthalene, gasoline, propane, petroleum resins, Stoddard solvent, triethanolamine, toluene, xylene, acetic acid ethenyl ester, N-butyl acetate, 1-methoxy-2-propyl acetate, 2-butoxyethyl acetate, D-limonene, muriatic acid.

The chemical additive(s) may be applied in any suitable manner. For example, in some embodiments, the chemical additive(s) are poured into the mixture. In other embodiments, the chemical additive(s) are sprayed on the mixture. In other embodiments, additives are sprayed onto the expanded polystyrene, which is then added to the cement. Spraying of the chemical additive(s) may improve distribution of the chemical additives throughout the mixture. In other words, spraying of the chemical additives into the mixture may result in a more uniform mixture. In some circumstances, the chemical additive(s) are delivered into a mold soon after addition of the chemical additive(s). For example, in some embodiments, the chemical additive(s) are added to the mixture no more than three hours, two hours, one hour, 30 minutes, 15 minutes, and/or five minutes before placing the cement-containing composition into a mold to produce a cement-containing form. In some embodiments, the mixture may be removed from the mold within a relatively short amount of time. For example, in some embodiments, the mixture is placed within the mold for less than 20 minutes, less than 30 minutes, and/or less than 45 minutes and then removed. Suitable molds may be made from hard plastic, aluminum, or steel. One or more release agents, such as vegetable oil, may be applied to an interior surface of the mold to promote release of the resulting wall. In some embodiments, the cement-containing composition that is placed in the mold is then compressed. Such compression may increase the strength of the form, create a smooth finish, and/or help waterproof the end product. For example, in some embodiments, the mixture is compressed approximately 20%-30%. An augur mixer may be used in some instances. Use of an augur may increase uniformity of the composition.

In some embodiments, Ultraflex®, such as Ultraflex® 2 may be added to the mixture. In some embodiments, crystalline silica and/or silica sand may be added to the mixture. In some embodiments, epoxy and enamels are added to the mixture. In some embodiments, a vinyl polymer is added to the mixture. In some embodiments, a silicone resin is added to the mixture. In some embodiments, triethoxycaprylylsilane is added to the mixture.

Once the forms have cured, grooves can be cut into the forms to run electrical wire for electrical needs. The grooves can then be filled in with grout. Plumbing may also be installed. For example, a high-speed router with a carbide bit and laser pointer can be used to ensure that there is an accurate and straight groove. Windows and door frames can also be mounted into the forms using screws and other fasteners. Exterior surfaces (e.g., brick, stone, wood, stucco) can be applied to the forms without any additional support.

In some circumstances, one or more finishes may be applied to interior or exterior of the forms, though no separate finish is applied in some embodiments.

The resulting forms can have a density that is less than 50%, less than 40%, less than 30%, and/or less than 20% of traditional concrete. For example, in some embodiments, a 12′×3.5″×4′ form is approximately 100 pounds. Forms having a wide variety of dimensions can be manufactured as desired.

The cement-containing forms described herein can be used for any suitable purpose. For example, in some embodiments, the cement-containing form is used to form a concrete wall. More specifically, concrete or other cement-containing material may be poured into the concrete-containing forms to produce a concrete wall.

Wiring and/or plumbing may be installed in a cement-containing form without the need for interior framing. In other words, some cement-containing forms do not require interior framing for exterior and/or interior walls. Windows and/or doors can also be secured within the cement-containing forms. In some embodiments, a cement containing form does not cause honeycomb and/or rock deposits to form due to the use of ties. In some embodiments, the cement-containing form does not use grout. In some embodiments, the cement-containing forms may be adjusted for grade elevation changes. In some embodiments, the cement-containing forms described herein can allow for the simultaneous construction of several floors. The cement-containing forms described herein can also reduce the amount of waste per job due to different size walls, pitches, and angles, as well as wood waste from interior framing. The cement-containing compositions described herein generally do not burn (i.e., are fireproof), enhancing safety. The cement-containing compositions described herein may allow for insertion of rebar according to specific job needs, and need not limit the position of rebar to specific preset distances. The cement-containing compositions described herein can reduce or eliminate the need for metal forms. Labor can also be reduced as there may be no need to remove the cement-containing forms once the cement has set (e.g., approximately three days under normal conditions).

Some cement-containing forms described herein can be used to form nonstructural interior walls. The ease of construction of such non-structural interior walls may reduce or eliminate the need for interior framing of a building, as electrical wiring can be routed into the cement form or have conduits put right into the walls when they are being made. Some cement-containing forms described herein can be used to make an insulating structural wall.

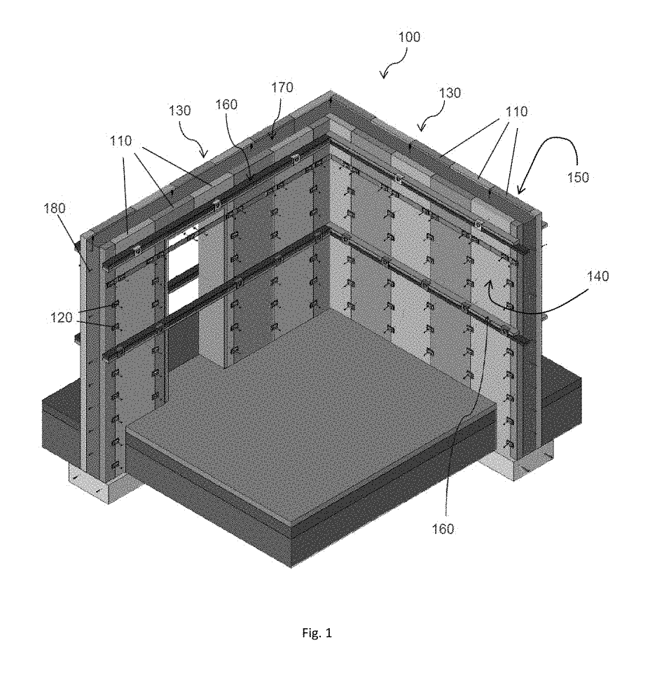

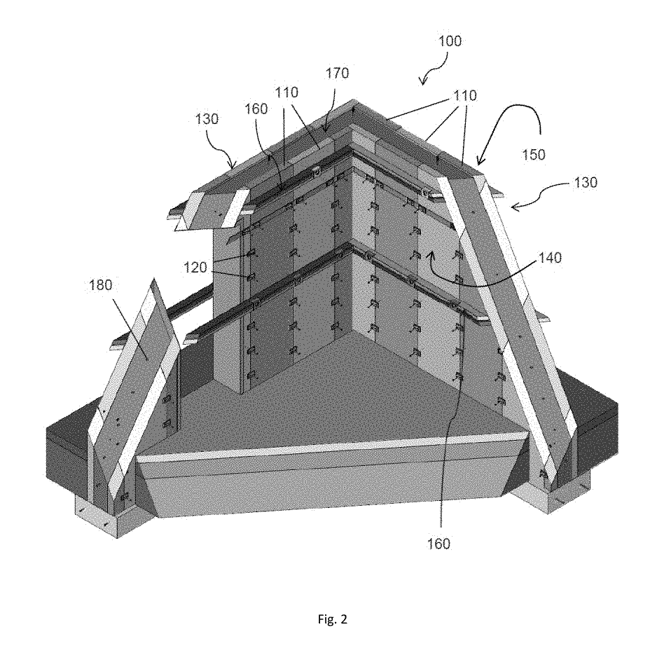

An exemplary embodiment of a structure 100 formed by cement-containing forms 110 is shown in FIGS. 1 and 2. More particularly, FIG. 1 provides a perspective view of the structure 100, while FIG. 2 provides a partially cutaway perspective view of the same structure 100.

As shown in FIGS. 1 and 2, the structure 100 may include a plurality of cement-containing forms 110. The cement-containing forms 110 may be coupled to one another via ties 120 to form one or more walls 130. In the depicted embodiment, the walls 130 are formed from a first set of cement-containing forms 110 that form an interior surface 140 and a second set of forms that form an exterior surface 150. In some embodiments, bracing 160 may be used to ensure alignment of the walls 130. A cement-containing composition 170 may be poured between the outer cement containing forms 110 and the inner cement-containing forms 110. In some embodiments, rebar 180 or other reinforcing material is used to increase the strength of the cement-containing composition 170. In some embodiments, the cement-containing forms 110 remain in place after the cement-containing composition 170 has dried. The cement-containing forms 110 thus may form an interior surface 140 and an exterior surface 150 of a wall 130. A skilled artisan will recognize that the cement-containing forms 110 and related structures depicted in FIGS. 1 and 2 are only exemplary, and do not limit this disclosure.

### EXAMPLES

### Example 1—Cement-Containing Form

A cement-containing form was manufactured by combining expanded polystyrene (12 L), soft fiber (1 cup), cement (2.37 L), Komponent® (1.2 L), and sand (500 mL). Approximately 1.5 L of water was used. The resulting mixture was used to create a form panel (without compression). The form panel had a resistive compression strength of 760 psi.

### Example 2—Cement-Containing Form

A cement-containing form was manufactured by combining expanded polystyrene (25 L), soft polymer fiber (0.5 oz), cement (4.5 L), Komponent® (1 L), and non-calcium chloride (500 mL). Approximately 2.5 L of water was used. The resulting mixture was used to create a form panel (without compression). The form panel had a resistive compression strength of 740 psi, and after 50% compression, a thermal conductivity of 0.62, and an R-value of 1.6 per inch.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

We claim:

1. A cement-containing form comprising:
cement; and
expanded polystyrene;
wherein the cement-containing form has a resistive strength of greater than 700 psi.

2. The cement-containing form of claim 1, wherein the cement-containing form is substantially devoid of sand, gravel, and rock.

3. The cement-containing form of claim 2, wherein the ratio of expanded polystyrene to cement is greater than 3:1 by volume.

4. The cement-containing form of claim 2, wherein the ratio of expanded polystyrene to cement is greater than 4:1 by volume.

5. The cement-containing form of claim 1, wherein the expanded polystyrene comprises polystyrene beads of less than ¼ inch in diameter.

6. The cement-containing form of claim 1, wherein the cement comprises calcium oxide and silica.

7. The cement-containing form of claim 1, further comprising one or more of acrylic enamel, acrylic urethane, and acrylic lacquer.

8. The cement-containing form of claim 7, wherein the one or more of acrylic enamel, acrylic urethane, and acrylic lacquer are less than 5% of the cement-containing form by volume.

9. The cement-containing form of claim 1, further comprising one or more of ether, methylene chloride, methyl ethyl ketone, 1,3,-diethenyl benzene, benzene, ethyl benzene, heptane, 1,3,5-trimethylbenzene, 1,3,5-trimethylbenzene mesitylene, alcohols such as methanol and ethanol, methylcyclohexane, naphtha, naphthalene, gasoline, propane, petroleum resins, Stoddard solvent, triethanolamine, toluene, and xylene.

10. The cement-containing form of claim 9, further comprising an acid or a base.

11. A method of forming a wall, the method comprising: obtaining one or more cement-containing forms, wherein the one or more cement-containing forms comprise expanded polystyrene;
positioning the one or more cement-containing forms such that the one or more cement-containing forms are positioned to form an exterior of a wall; and pouring a flowable cement-containing composition into the forms.

12. The method of claim 11, wherein the method further comprises leaving the cement-containing forms in place as a permanent insulation barrier after the flowable cement-containing composition has dried.

13. A method for manufacturing a cement-containing form, the method comprising: combining cement with expanded polystyrene and at least one of an acrylic component, an ether, methylene chloride, methyl ethyl ketone, 1,3,-diethenyl benzene, benzene, ethyl benzene, heptane, 1,3,5-trimethylbenzene, 1,3,5-trimethylbenzene mesitylene, alcohols (e.g., methanol, ethanol, etc.), methylcyclohexane, naphtha, naphthalene, gasoline, propane, petroleum resins, Stoddard solvent, triethanolamine, toluene, and xylene to form a mixture;
placing the mixture into a mold;
compressing the mixture into the mold; and
drying the mixture within the mold.

14. The method of claim 13, wherein the cement and expanded polystyrene are mixed with an acid or a base.
